(19) United States
(12) Patent Application Publication
(10) Pub. No.: US 2007/0174234 A1
(43) Pub. Date: Jul. 26, 2007

(54) Data quality and validation within a relational database management system

(75) Inventor: Mark S. Ramsey, Kihei, HI (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/338,541

(22) Filed: Jan. 24, 2006

(51) Int. Cl. G06F 17/30

(52) U.S. Cl. 707/2

(57) ABSTRACT

A system and method for performing data quality and validation analysis within a relational database management system (RDBMS). A method is provided that includes generating a summarization table for a set of data values using an RDBMS function after a modification of the set of values takes place; calculating a deviation from the summarization table using an RDBMS function; and querying the set of data values against the deviation to identify any suspect values.

### FIELD OF THE INVENTION

The invention relates generally to data validation, and more particularly, to a system and method for performing data quality and validation analysis within a relational database management system.

### BACKGROUND OF THE INVENTION

As businesses rely more and more on data to evaluate and implement their business processes, the size of databases and the use of relational database management systems continue to increase. A relational database management system (RDBMS) is a program that allows a user to create, update, and administer a relational database. A relational database is a collection of data items organized as a set of formally-described tables from which data can be accessed or reassembled in many different ways without having to reorganize the database tables. Most commercial RDBMSs use the Structured Query Language (SQL) to access the database. Leading RDBMS products include IBM's DB2®, ORACLE®, and Microsoft's SQL SERVER®.

The quality and validity of data that is added to a database is a critical focus area for many organizations. Adding invalid or incorrect data into a database can be costly, as it may result in the need for later correction or may result in poor business decisions. Most organizations attempt to validate the quality of data using filters within the software applications that collect the data to be added to the database. This approach can be effective for preventing mistakes such as, e.g., text being entered in a numeric field, entering too many characters for a field, etc. However, such techniques do little to identify skews in numeric values, such as low or high ages, dollar amounts outside a normal range, etc.

One approach to addressing the problem of identifying skewed data is to provide external software tools that check for numeric ranges, etc. Unfortunately, this approach is costly, as it requires custom software applications that are expensive to acquire and maintain. Accordingly, a need exists for system and method the can analyze and validate database data without the need for external software tools.

### SUMMARY OF THE INVENTION

The present invention addresses the above-mentioned problems, as well as others, by providing a system and method for performing data quality and validation analysis within a relational database management system using dynamically created summarizations.

In a first aspect, the invention provides a method for validating data being inputted into a relational database management system (RDBMS), comprising: generating a summarization table for a set of data values using an RDBMS function after a modification of the set of data values takes place; calculating a deviation from the summarization table using an RDBMS function; and querying the set of data values against the deviation to identify any suspect values.

In a second aspect, the invention provides a method for validating data being inputted into a relational database management system (RDBMS), comprising: generating a summarization table for a set of data values using an RDBMS function; calculating a deviation from the summarization table using an RDBMS function; proposing an addition of a new data value into the set of data values; and comparing the new data value with the deviation to determine if the new data value is a suspect value.

In a third aspect, the invention provides a relational database management system (RDBMS) that includes data validation capabilities, comprising: a system for generating a summarization table for a set of data values using an RDBMS function after a modification of the set of values takes place; a system for calculating a deviation from the summarization table using an RDBMS function; and a system for querying the set of data values against the deviation to identify any suspect values.

In a fourth aspect, the invention provides a computer program product stored on a computer useable medium for validating data being entered into a database, comprising: a relational database management system (RDBMS) having: program code configured for generating a summarization table for a set of data values using an RDBMS function; program code configured for calculating a deviation from the summarization table using an RDBMS function; and a data preprocessor having program code configured for comparing a new data value being inputted into the RDBMS with the deviation to determine if the new data value is a suspect value.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having a relational database management system in accordance with the present invention.

FIG. 2 depicts a flow chart for implementing a first embodiment of the invention.

FIG. 3 depicts a flow chart for implementing a second embodiment of the invention.

### DETAILED DESCRIPTION OF THE INVENTION

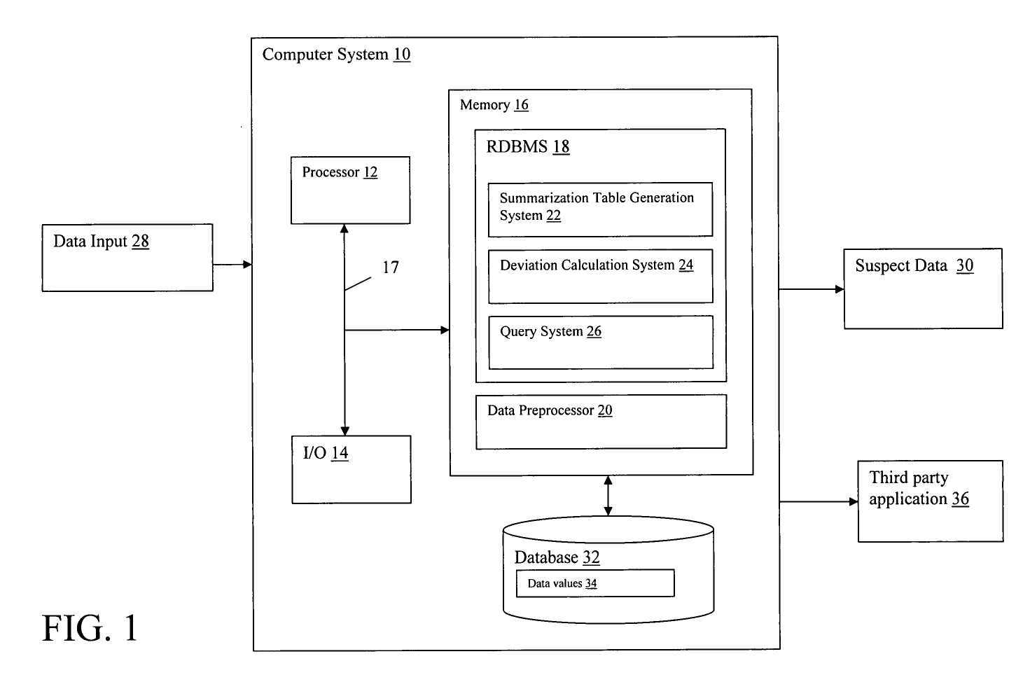

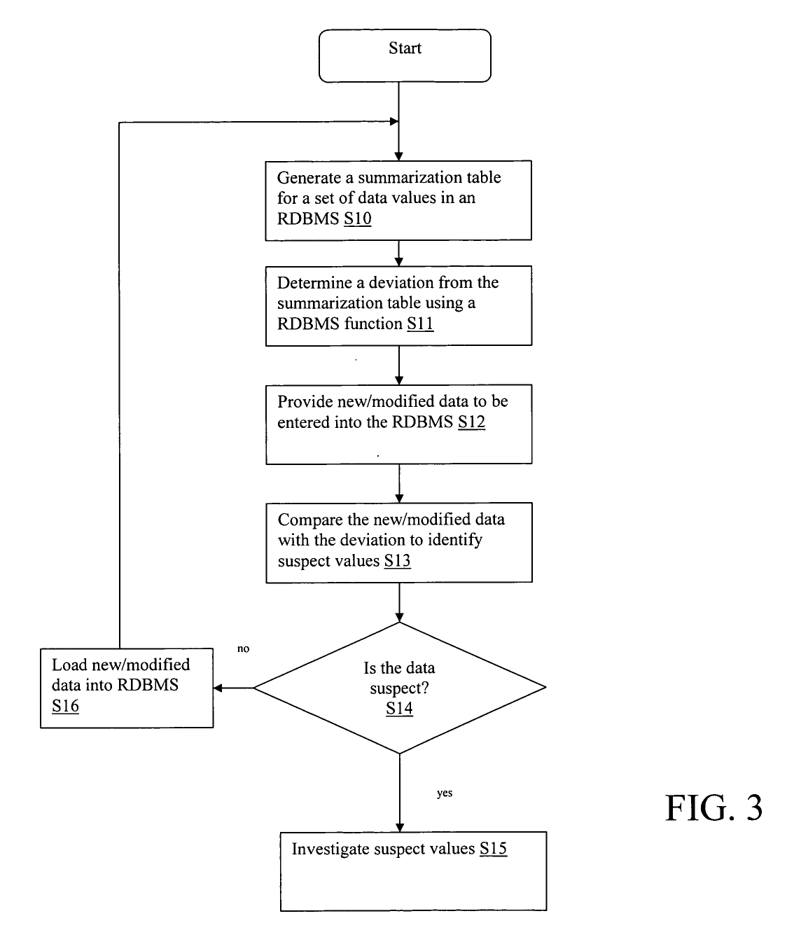

Referring now to drawings, FIG. 1 depicts a computer system 10 having a relational database management system (RDBMS) 18 that utilizes actual historical data values 34 to validate data 28 being inputted into (or modified within) RDBMS 18. Note that inputted data 28 may include additions or modifications of data. Accordingly, for the purposes of this disclosure, the concepts of modifying and adding data are used interchangeably and thus have the same meaning. As shown, RDBMS 18 includes a summarization table generation system 22, a deviation calculation system 24, and a query system 26. Also included in computer system 10 is a data preprocessor 20, which may be utilized, e.g., in the embodiment described below with respect to FIG. 3.

Many state of the art RDBMSs, such as the IBM DB2 database include functionality to create summarization tables of data values 34 stored in a database 32.

Namely, attributes in a table may be automatically summarized in an attribute table. The summarization tables may be generated dynamically as data 28 is being added into (or modified within) the database 32, or be done on an as needed basis on existing data values 34. Within IBM DB2, this function is implemented as Automatic Summary Tables (AST). The present invention utilizes the summarization facilities within RDBMS 18, namely summarization table generation system 22, to summarize a set of numeric items into a “norm” and then calculate a specified deviation from the norm utilizing deviation calculation system 24. The deviation is maintained by RDBMS 18 and can be automatically updated as new data 28 is added to the RDBMS 18. The deviation may comprise, e.g., a number, a set of thresholds, a range, a function, etc.

For instance, if based on a statistical analysis, the norm for a set of data was calculated as 100 plus or minus 50, then the deviation may be calculated as a range of values between 50 and 150. Query system 26, which is likewise a standard utility found within most relational database management systems, may be utilized to run a query that identifies records within the database 32 that “deviate” from the norm, i.e., that fall outside the deviation. Thus, for this example, any values below 50 or greater than 150 would be considered suspect.

Calculation of the norm and deviation may be done in any manner, e.g., using mean, weighted averages, ranges, standard deviation, multiples of standard deviation, statistical analysis, etc. RDBMSs, such as IBM DB2, have the ability to determine the standard deviation across rows of a source database using an aggregate function. (Thus, the summarization table can be configured to automatically calculate the standard deviation in a single step.) If methods other than standard deviation are used to establish the deviation, then either some other built-in RDBMS function could be used, or a user-defined RDBMS function could be used. In any case, the functional capabilities to perform these calculations occur within the RDBMS itself, thus requiring no external application to be written and/or maintained.

Once created, the summarization table (e.g., AST) is maintained and updated by the RDBMS 18 as data 28 is added or existing data values 34 change. Depending on the changes or additions, a new deviation may result. Depending on the RDBMS, the summarization table may either be dynamically updated whenever a change or addition occurs, or be manually “refreshed.”

The deviation calculated from the summarization table may also be used by data preprocessor 20 within a pre-preprocess step to check new data before it is added to the RDBMS 18. That is, data values that are being proposed to be loaded into RDBMS can be checked ahead of time to see if any of the data values are suspect. Similarly, the baseline deviation/summarization table information may be used by a third party application 36 to validate data before it is loaded to RDBMS 18. In both cases, the summarization table and deviation is maintained and calculated dynamically by RDBMS 18 based on actual data values 34, as opposed to using static values hard coded in a third party application 36.

Note that certain deviations may remain constant over a long period of time, such as entries relating to the norm value for the age of a driver for an auto policy. Conversely, other deviation values, such as those based on average ATM withdrawal amounts for a customer, may increase over time. Accordingly, what may have been considered a suspect value in the past (e.g., a $1000 withdrawal), may no longer be suspect. Thus, for those sets of values that tend to fluctuate over time, such changes would be automatically captured and used by the data validation processes described herein.

In general, computer system 10 may comprise any type of computing system. Moreover, computer system 10 could be implemented as part of a client and/or a server. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms. I/O 14 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Access to computer system 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

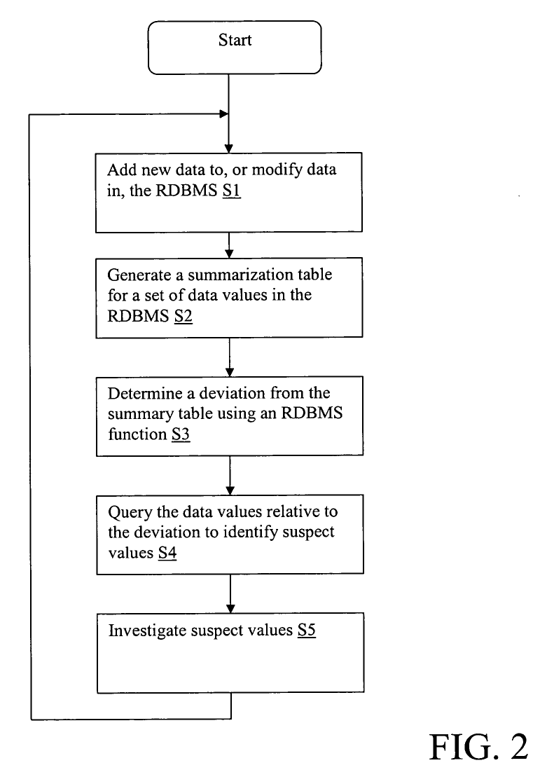

Referring now to FIG. 2, a flow chart of a first illustrative embodiment for implementing the invention is provided. At step S1, data is added to or modified in the RDBMS 18. At step S2, a summarization table is generated/updated for a set of data values 34 (containing the added/modified data) in the RDBMS 18. At step S3, a deviation is calculated from the summarization table using an RDBMS function, such as standard deviation, etc. At step S4, the data values 34 are queried against the deviation to identify any suspect values. At step S5, any suspect values are investigated, and control returns to step S1. Accordingly, in this case, a summarization table for a set of data values is updated when the set of data values change. The updated summarization table can then be used to validate the set of data values using a query function.

Referring now to FIG. 3, a flow chart of a second illustrative embodiment for implementing the invention is provided. First at step S10, a summarization table for a set of values in a RDBMS 18 is generated. Next, at step S11, a deviation is calculated from the summarization table using an RDBMS function, such as standard deviation, etc. At step S12, one or more new or modified data values are provided/proposed to be entered into the RDBMS 18. At step S13, the one or more new or modified data values are compared to the deviation to identify any suspect values, e.g., using a data preprocessor 20. At step S14, a determination is made whether the one or more new or modified data values are suspect, and if so, the value(s) are investigated at step S15. Otherwise, the one or more new or modified data values are loaded into the RDBMS at step S16, and control returns to step S10.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet.

The present invention can also be embedded in a computer program product, which comprises all the features enabling the implementation of the methods and functions described herein, and which —when loaded in a computer system —is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for validating data being inputted into a relational database management system (RDBMS), comprising:
generating a summarization table for a set of data values using an RDBMS function after a modification of the set of data values takes place;
calculating a deviation from the summarization table using an RDBMS function; and
querying the set of data values against the deviation to identify any suspect values.

2. The method of claim 1, wherein the modification includes an addition of new data.

3. The method of claim 1, wherein the generating step dynamically generates the summarization table whenever the set of data values changes.

4. The method of claim 1, wherein the generating and calculating steps are performed as a single process.

5. The method of claim 1, wherein the deviation is selected from the group consisting of:
a mean, a weighted average, a range, a standard deviation, a multiple of a standard deviation, and a statistical analysis.

6. The method of claim 1, comprising the further step of: investigating any suspect values.

7. A method for validating data being inputted into a relational database management system (RDBMS), comprising:
generating a summarization table for a set of data values using an RDBMS function;
calculating a deviation from the summarization table using an RDBMS function;
proposing an addition of a new data value into the set of data values; and
comparing the new data value with the deviation to determine if the new data value is a suspect value.

8. The method of claim 7, wherein the addition of new data includes a modification of existing data in the set of data values.

9. The method of claim 7, wherein the generating step dynamically generates the summarization table whenever the set of data values changes.

10. The method of claim 7, wherein the generating and calculating steps are performed as a single process.

11. The method of claim 7, wherein the deviation is selected from the group consisting of: a mean, a weighted average, a range, a standard deviation, a multiple of a standard deviation, and a statistical analysis.

12. The method of claim 7, comprising the further step of: investigating the new data value if the new data value is a suspect value.

13. A relational database management system (RDBMS) that includes data validation capabilities, comprising:
a system for generating a summarization table for a set of data values using an RDBMS function after a modification of the set of data values takes place;
a system for calculating a deviation from the summarization table using an RDBMS function; and
a system for querying the set of data values against the deviation to identify any suspect values.

14. The RDBMS of claim 13, wherein the modification includes an addition of new data.

15. The RDBMS of claim 13, wherein the system for generating a summarization table generates the summarization table whenever the set of data values changes.

16. The RDBMS of claim 13, wherein the deviation is selected from the group consisting of: a mean, a weighted average, a range, a standard deviation, a multiple of a standard deviation, and a statistical analysis.

17. A computer program product stored on a computer useable medium for validating data being entered into a database, comprising:
a relational database management system (RDBMS) having:
program code configured for generating a summarization table for a set of data values using an RDBMS function;
program code configured for calculating a deviation from the summarization table using an RDBMS function; and
a data preprocessor having program code configured for comparing a new data value being inputted into the RDBMS with the deviation to determine if the new data value is a suspect value.

18. The computer program product of claim 17, wherein the new data includes a modification of existing data in the set of data values.

19. The computer program product of claim 17, wherein the summarization table is generated dynamically whenever the set of data values changes.

20. The computer program product of claim 17, wherein the deviation is selected from the group consisting of: a mean, a weighted average, a range, a standard deviation, a multiple of a standard deviation, and a statistical analysis.
